(19) United States
(12) Patent Application Publication
(10) Pub. No.: US 2006/0037013 A1
(43) Pub. Date: Feb. 16, 2006

(54) Program update apparatus, method, and medium

(75) Inventor: Seoung-chul Kang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/204,096

(22) Filed: Aug. 16, 2005

(30) Foreign Application Priority Data
Aug. 16, 2004 (KR) 2004-64380

(51) Int. Cl. G06F 9/44

(52) U.S. Cl. 717/168; 717/171

(57) ABSTRACT

A program update apparatus, medium, method, including an electronic apparatus having a processor, a system memory to load a program to be executed by the processor, an update client to receive predetermined update information from an external update server and to request the executed program to be updated, and an operating system to update symbols not currently being used by the processor among the symbols of the program stored in the system memory, based on the update information and at the request of the update client. Thus embodiments of the present invention include an electronic apparatus and a program update method thereof, where the update can be performed without an interrupt routine and a program can be updated while it is running.

### CROSS-REFERENCE TO RELATED APPLICATIONS

This application claims the priority benefit of Korean Patent Application No. 2004-64380, filed on Aug. 16, 2004, in the Korean Intellectual Property Office, the disclosure of which is incorporated herein by reference.

### BACKGROUND OF THE INVENTION

1. Field of the Invention

Embodiments of the present invention relate to a program update apparatus, method, and medium, and more specifically, an electronic apparatus, method, and medium for program upgrades during execution of a program.

2. Description of the Related Art

An electronic apparatus such as a personal computer (PC), an embedded system, etc., can be embedded with various software programs. The embedded software program can typically be regularly, or occasionally, updated by receiving a software patch from a remote server, for example.

The software program may also include an update routine in every section thereof, with sections of the software program being allocated in consideration of various matters. For example, sections of the software program may be previously allocated in consideration of the number of loops, a schema of software design, a schema of hardware design, a requirement of software modification, a requirement of software correction, etc., when the software program is designed, for example.

The update routine inserted/compiled in an initial part of a section can retrieve a corresponding patch table, and determines whether an update is needed or not. When an update is needed a corresponding section may be updated by accessing a corresponding patch program.

Because the update routines may be inserted in every section, the number of accesses to the patch table increases in proportion to the number of sections or the length of program code. Thus, such a program structure results in deteriorated performance of an electronic apparatus. Further, the method of inserting the update routine in every section may not be supported by a general programming language, so it may not be easy to apply the foregoing update method to the corresponding software program.

Meanwhile, some of the embedded programs and/or system may need, or be desired to, operate around the clock continuously for 24 hours, such that it may be difficult to apply conventional program update methods. That is, the conventional program update method cannot be performed while the program is running, i.e., the update is performed after terminating a corresponding program.

Further, because it is impossible to relocate a previously allocated section, even though a software program is in need of redesign, the structure of the software program should be not changed in order to apply the conventional program update method thereto. Therefore, the conventional program update method further restricts development of the software program.

### SUMMARY OF THE INVENTION

Accordingly, it is an aspect of the present invention to provide a program update apparatus, medium, and method, including an electronic apparatus and a program update method thereof, wherein the update is performed without an interrupt routine being applied so a corresponding program can be updated while it is running.

To achieve the above and/or other aspects and advantages, embodiments of the present invention include an apparatus, including a system memory to store a program to be executed by a processor, an update client to receive update information and to request a program being executed by the processor to be updated, and an operating system to update symbols, of the executing program, not being used by the processor among symbols of the program, based on the update information and at the request of the update client.

Here, the update information may be received by the update client from an external update server.

The operating system may inform the update client that a process of the executing program is terminated when the process using symbols to be updated is terminated, and the update client may receive information about the termination of the process and requests the corresponding symbols be updated. Further, the update client may determine whether the symbols of the program are in use, and request the operating system to inform the update client when the use of the symbols are terminated.

The symbol may further include a program function and a global function.

The apparatus may also include a debug interface to inform the update client whether predetermined symbols are being used by the processor, wherein the update client requests the operating system to update corresponding symbols when the debug interface informs the update client that use by the processor of the corresponding symbols is terminated.

To achieve the above and/or other aspects and advantages, embodiments of the present invention include a program update method, including determining whether a program to be updated, as determined by the update information, is loaded into a system memory and being executed by a processor, requesting an operating system to perform an update of the program, and updating, by the operating system, symbols of the program not being used by the processor, among symbols of the program, based on the update information at the request of the update client to perform the update of the program.

The update information may be received from an external server separate from the processor and the update client performing the receipt of the update information.

In addition, the updating of symbols may further including determining whether the processor terminates using previously in-use symbols to be updated by the operating system, and updating the previously in-use symbols based on the update information when use of the previously in-use symbols is terminated.

The method may still further include accessing an update server, separate from the update client receiving the update information, and determining whether a memory includes a program available for update by the update server based on information from the update server indicating an available update, wherein the receiving of the update information is performed by the update client, from the update server, when the memory includes the program available to be updated.

In addition, the method may include determining a location of the symbols of the program to be updated, as stored in a memory, based on a rearrange table, as well as updating the program, as stored in a nonvolatile memory, when the program to be updated is not loaded into the system memory.

To achieve the above and/or other aspects and advantages, embodiments of the present invention include at least one medium including computer readable code to implement embodiments of the present invention.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 illustrates a schematic control block diagram of an electronic apparatus, according to an embodiment of the present invention;

FIG. 2 schematically illustrates a file structure used in a typical program; and

FIG. 3 illustrates a control flowchart of a program upgrade method, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to like elements throughout. The embodiments are described below in order to explain the present invention by referring to the figures.

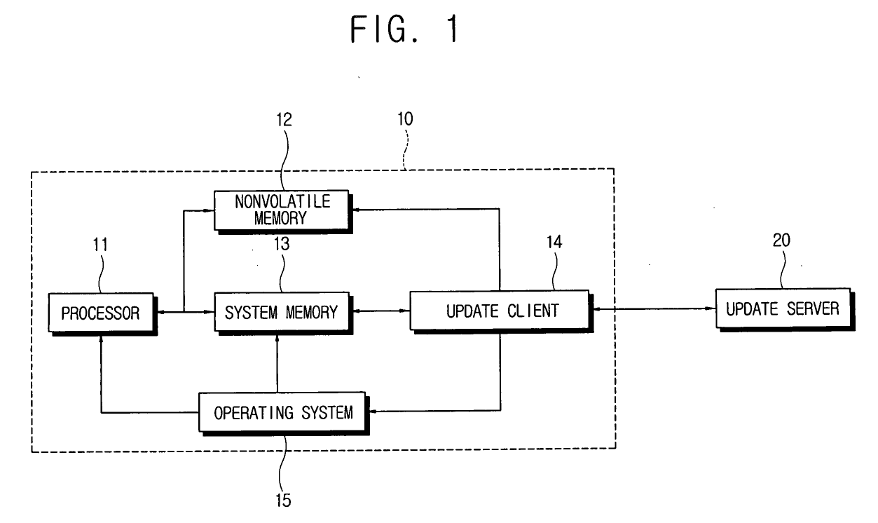

FIG. 1 illustrates a schematic control block diagram of an electronic apparatus, according to an embodiment of the present invention.

As shown in FIG. 1, an electronic apparatus 10 may include a processor 11, a nonvolatile memory 12, a system memory 13, an update client 14, and an operating system 15, for example.

The processor 11 may execute a program, including performing operations as a central processing unit (CPU) of a computer, but may vary according to the data processing performances needed for the electronic apparatus 10.

The nonvolatile memory 12 can store a large amount of program data, realized by a hard disk drive, a read only memory (ROM), an electronically erasable programmable read only memory (EEPROM), a memory card, etc, for example.

The system memory 13 may include a volatile memory with a short accessing time for the processor 11, and may further include a cache memory, as necessary. When the processor 11 executes a program stored in the nonvolatile memory 12, the corresponding program can be loaded into the system memory 13 and program routines thereof can be executed in sequence, for example.

As an example, the update client 14 could receive predetermined update information from an update server 20, and perform the update according to locations of a corresponding program symbol to be updated. For this, the electronic apparatus 10 could include a communication interface, a communication controller, an update software program, etc., to data communication with the update server 20, for example.

Here, the program symbol should be interpreted as including a program function and a global function, with its location being capable of being retrieved through a rearrange table of the program, for example.

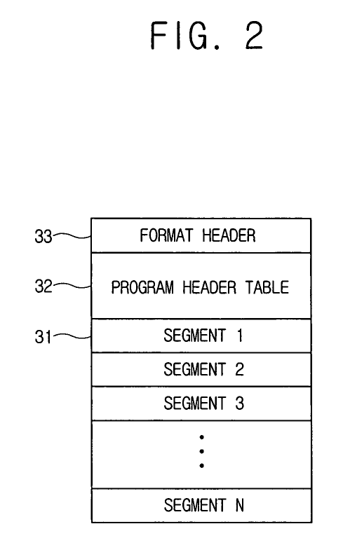

FIG. 2 schematically illustrates a structure of a typical file that may be used in most programs.

As shown in FIG. 2, the structure of the file may include segments 31 where the program data is stored, a program header table 32 storing information about the segments 31, and a header 33 storing information of formats.

The program header table 32 can store all kinds of information for executing the program, e.g., names and the sizes of the symbols, relative locations of code for each symbol in the memory, and the rearrange table for managing the same. Here, the rearrange table can dynamically manage an address of each symbol, to execute the program, at any location of the memory. The rearrange table may be called various names according to file formats, and may vary a little with regard to configuration of the system and program type.

As described above, the update client 14 can determine the stored location of a corresponding program symbol through the rearrange table, and can perform an update according to the location(s) of the program symbol.

For example, a symbol stored in the nonvolatile memory 12 may be directly updated based on the corresponding update information. Conversely, a symbol of a running (executing) program, which may be stored in the system memory 13, can be requested to be updated by the operating system 15.

When there is a request for the update, from the update client 14, the operating system 15 can perform the update of the symbol that is not currently being used by the processor 11, among the program symbols currently executed by the processor 11.

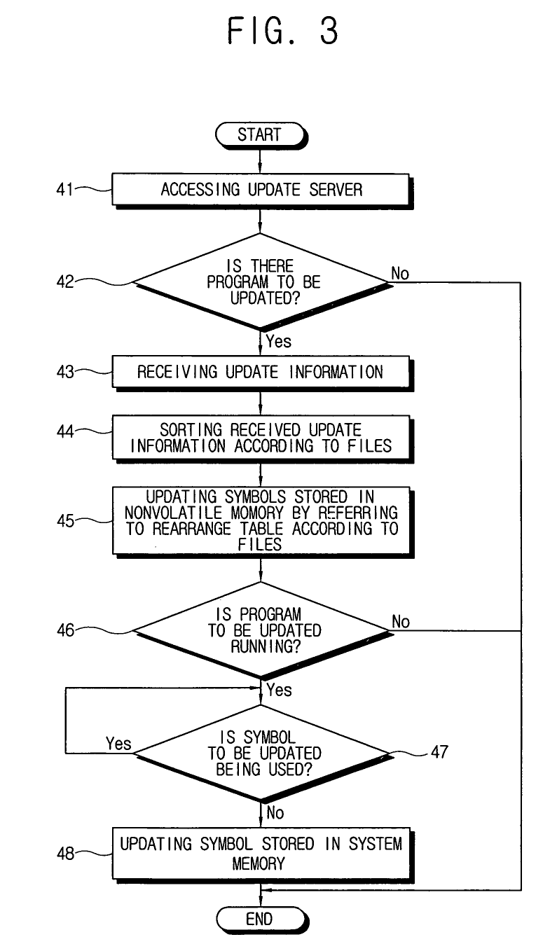

FIG. 3 illustrates a control flowchart of a program upgrade method, according to an embodiment of the present invention. Referring to FIG. 3, the electronic apparatus of FIG. 1, for example, can be operated as follows.

When a program is executed, the operating system 15 reads the header 33 of the program file, and calls a suitable loader, so that each loader loads the program header table 32 and the segment 31 into the system memory 13. Then, the operating system 15 can set the processor 11 to perform a routine from the program storing location of the system memory 13, and the processor 11 can execute the routine from the starting location of the program.

In operation S41, the update client 14 may communicate with the update server 20, for example. In operation 42, the update client 14 may also determine whether there is a program to be updated among programs stored in the electronic apparatus 10, for example, through data communication with the update server 20. Here, connection between the update client 14 and the update server 20, to determine whether there is a program to be updated, may also be regularly performed or occasionally performed when there is a corresponding request from the update server 20.

When the update client 14 determines that a program is to be updated, in operation 43, the update client 14 receives update information needed for the update from the update server 20, for example. Here, the update information can include the name of the program to be updated, a symbol name, a code size, etc., for example. Further, the received update information may be selectively stored in the nonvolatile memory 12, the system memory 13, etc.

In operation 44, the update client 14 can sort and store the received update information according to files, for example. In operation 45, the update client 14 may read the rearrange table of each file from the nonvolatile memory 12, and obtain information about symbols to be updated.

In operation 45, each part of the program stored in the nonvolatile memory 12 may be updated based on the read information. Accordingly, each program can be updated to be executed with the updated code upon the next execution.

After the files stored in the nonvolatile memory 12 are completely updated, for example, the update client 14 can determine whether there are programs to be updated among programs being run by the processor 11, in operation 46.

When it is determined that a program to be updated is currently being run by a processor, a symbol loaded into a stack of the corresponding program is retrieved, thereby determining whether that symbol to be updated is currently being used by the processor 11, in operation 47. Here, the stack can be a temporary storage region of the system memory 13 to store various symbols when a program calls a function, for example.

Therefore, the stack can be retrieved to determine what symbols are in use, but it can not be ensured that the program will normally operate after the currently used symbol stored in the stack is updated. That is, the corresponding symbol should be terminated to update the symbol being used by the processor 11.

Whether the use of the symbol is terminated can be determined based on whether a stack frame is released. The stack can be created by calling and loading the function and can be released by the termination of the corresponding symbol. To determine when the stack frame is released, the operating system 15 can be set to sense and inform the update client 14 when an event is generated.

When it is determined that the symbol to be updated is being used by the processor 11, the update client 14 can request the operating system 15 inform the update client 14 when the corresponding symbol has terminated.

When the event related to the request is generated, the operating system 15 can inform the update client 14 of the event generation. Then, the update client 14 can request that the operating system 15 update the symbol stored in the system memory 13.

In operation 48, the operating system 15 can perform the update based on the update information corresponding to the requested symbol. Here, the update of the symbol stored in the system memory 13 may be performed by only the operating system 15, so that coding performing the update at the request of the update client 14 can be added.

When the update is successfully completed, the update client 14 preferably, though not limited thereto, informs the update server 20 of the successful update, thereby preventing the same update service from being repetitively performed.

According to an embodiment of the present invention, when the use of the symbol is terminated, the operating system 15 may also directly perform the update for the corresponding symbol without waiting the request of the update client 14.

Further, to sense whether the stack is released, a separate debug interface can be used without using the operating system 15. The debug interface may include a card mounted with an integrated chip (IC) debugging an operating state of a program or a system, a debugging program, etc.

According to an embodiment of the present invention, the update routines may not be separately inserted in every section, but the update may be performed on symbol units based on the update information received through the update client 14. Thus, even if the file size of the program is increased, the performance of the electronic apparatus 10 is not deteriorated.

In most programming languages, programs are sectioned by symbol units, so that update information can be more effectively generated and distributed. Further, when the program is in need of redesign, it is possible to redesign flexibly the whole structure of the program, so that the effective development of the program is allowed.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network, so that the computer readable code is stored/transferred and executed in a distributed fashion.

As described above, embodiments of the present invention provide a program update apparatus, medium, and method where a program can be updated while it is running, and the change of the program is allowed flexibly.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus, comprising:
a system memory to store a program to be executed by a processor;
an update client to receive update information and to request a program being executed by the processor to be updated; and
an operating system to update symbols, of the executing program, not being used by the processor among symbols of the program, based on the update information and at the request of the update client.

2. The apparatus of claim 1, wherein the update information is received by the update client from an external update server.

3. The apparatus of claim 1, wherein the operating system informs the update client that a process of the executing program is terminated when the process using symbols to be updated is terminated, and
the update client receives information about the termination of the process and requests the corresponding symbols be updated.

4. The apparatus of claim 3, wherein the update client determines whether the symbols of the program are in use, and requests the operating system to inform the update client when the use of the symbols are terminated.

5. The apparatus of claim 1, wherein a symbol includes a program function and a global function.

6. The apparatus of claim 1, further comprising a debug interface to inform the update client whether predetermined symbols are being used by the processor, wherein
the update client requests the operating system to update corresponding symbols when the debug interface informs the update client that use by the processor of the corresponding symbols is terminated.

7. A program update method, comprising:
receiving update information;
determining whether a program to be updated, as determined by the update information, is loaded into a system memory and being executed by a processor;
requesting an operating system to perform an update of the program; and
updating, by the operating system, symbols of the program not being used by the processor, among symbols of the program, based on the update information at the request of the update client to perform the update of the program.

8. The method of claim 7, wherein the update information is received from an external server separate from the processor and the update client performing the receipt of the update information.

9. The method of claim 7, wherein the updating of symbols further comprises:
determining whether the processor terminates using previously in-use symbols to be updated by the operating system; and
updating the previously in-use symbols based on the update information when use of the previously in-use symbols is terminated.

10. The method of claim 7, further comprising:
accessing an update server, separate from the update client receiving the update information; and
determining whether a memory includes a program available for update by the update server based on information from the update server indicating an available update,
wherein the receiving of the update information is performed by the update client, from the update server, when the memory includes the program available to be updated.

11. The method of claim 7, further comprising determining a location of the symbols of the program to be updated, as stored in a memory, based on a rearrange table.

12. The method of claim 7, further comprising updating the program, as stored in a nonvolatile memory, when the program to be updated is not loaded into the system memory.

13. At least one medium comprising computer readable code to implement the method of claim 7.
